(19) United States
(12) Patent Application Publication
(10) Pub. No.: US 2009/0172756 A1
(43) Pub. Date: Jul. 2, 2009

(54) LIGHTING ANALYSIS AND RECOMMENDER SYSTEM FOR VIDEO TELEPHONY

(75) Inventors: David J. Wheatley, North Barrington, IL (US); James E. Crenshaw, Palatine, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/967,363

(22) Filed: Dec. 31, 2007

(51) Int. Cl. H04N 7/173

(52) U.S. Cl. 725/106

(57) ABSTRACT

A home video system (200) capable of supporting video telephony includes a sub-system including a programmed processor (210) for analyzing illumination in a room (100) in which the system (200) is set up and recommending to the user of the system, lighting changes to avoid overwhelming the dynamic range of the camera (107), to optimize the ambient lighting and achieving a style of lighting selected by users of the system (200), thereby improving the video quality of the transmitted video image.

### FIELD OF THE INVENTION

The present invention relates generally to video telephony.

### BACKGROUND

The increased availability of high-speed network connections, the availability of inexpensive digital video cameras, improvements in video compression algorithms and availability of relatively inexpensive and powerful microprocessors has opened up the possibility of widespread point-to-point video communication.

While PC web cams have made video telephony available to anyone with a networked computer, there is an unfulfilled market for video communications outside the home office. It is anticipated that video telephony capability will be added to set-top boxes allowing people to use their television sets as video communication channels. The placement of video telephony in the living room will provide a more natural environment for social communications and will more easily allow multiple people to participate from a single site

It may not be apparent to the casual TV viewer that video cameras are quite limited in the range of light within a scene that they can accept without degrading the quality of the video noticeably. In this respect, the performance of video cameras is quite inferior to that of the human eye which can take in a scene with wide ranging brightness. To address the limitations of cameras, studios use multiple powerful light sources. Even when filming outside, powerful light sources are sometimes used to light actors or other persons being videoed.

One obstacle for home based video telephony, is that in general, the lighting in homes is not particularly suited for video cameras. In some cases the light level is inadequate and in other cases the positioning of lamps is improper. This is especially be the case in rooms where TVs are located.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 shows a living room in which a home video system capable of video telephony is set up;

FIG. 2 is a block diagram of a video telephony capable home video system including a display, a set top box and a remote control according to an embodiment of the invention;

FIG. 3 is a flowchart of a first sub-program executed by the set top box according to an embodiment of the invention;

FIGS. 4-5 are images illustrating the operation of the sub-program shown in FIG. 3;

FIG. 6 is a flowchart of a second sub-program executed by the set top box according to an embodiment of the invention; and

FIG. 7 is a flowchart of a third sub-program executed by the set top box according to an embodiment of the invention

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to automated lighting analysis and improvement recommendation for video telephony. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of automated lighting analysis and improvement recommendation for video telephony described herein. The non-processor circuits may include, but are not limited to, a radio receiver, a radio transmitter, signal drivers, clock circuits, power source circuits, and user input devices. As such, these functions may be interpreted as steps of a method to perform automated lighting analysis and improvement recommendation for video telephony. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

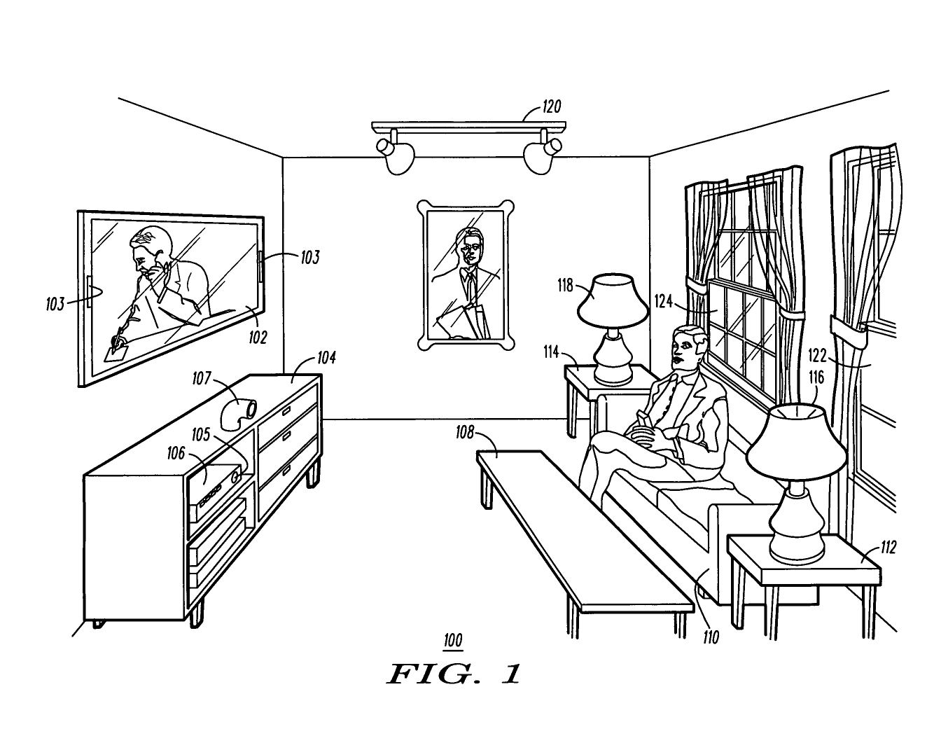

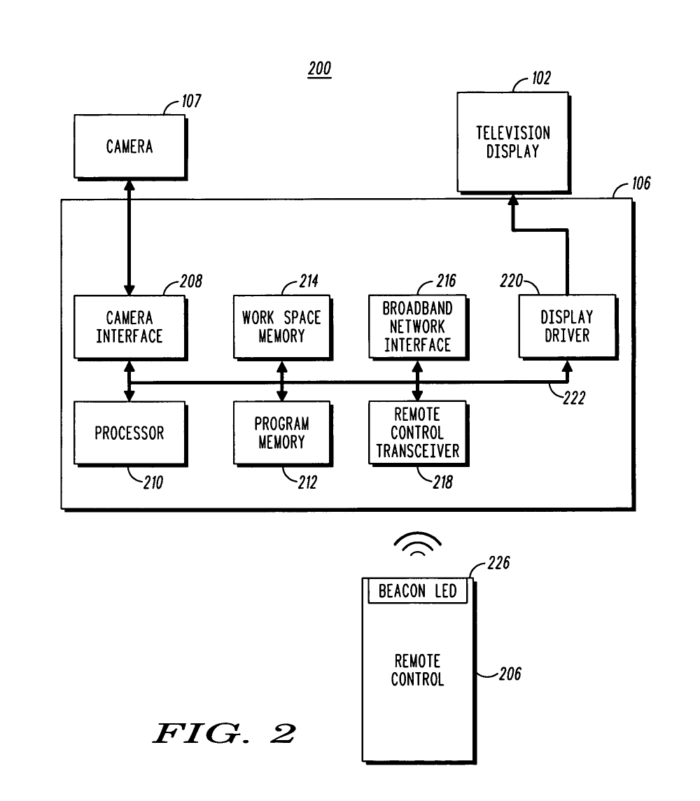

FIG. 1 shows a living room 100 in which a home video system 200 (FIG. 2) capable of video telephony is set up. A television display (e.g., flat panel, plasma, LCD, CRT or other) 102 is mounted above a low cabinet 104. The television display 102 includes built in audio speakers 103. A “set top box” 106 is located in the low cabinet 104. (Note that “set top boxes” 106 are typically located below today's larger televisions, so the name is something of an anachronism). A microphone 105 is incorporated into the set top box 106. A video camera 107 used to conduct two-way video telephony is located on the low cabinet 104. Alternatively, the video camera can be incorporated in the set top box 106. However because the set top box may not itself be optimally located for video telephony purposes, the additional technology and components needed to enable a videocall (including, but not limited to the camera 107, the microphone 105, speakers 103) may be mounted within a separate enclosure, which may be positioned on top of, adjacent or otherwise near to the TV display or set top box. A coffee table 108 and a sofa 110 are located opposite the television display 102 and the set top box 106. A first end table 112 and a second end table 114 are located on either side of the sofa 110. A first lamp 116 and a second lamp 118 are located on first end table 112 and the second end table 114 respectively. A set of overhead track lights 120 are located between the coffee table 108 and the television 102. A first window 122 and a second window 124 are located behind the sofa 110. As will be explained below in more detail, in order to achieve a lighting style selected by a user of the home video system 200, different combinations of the light sources 120, 116, 118, 122, 124 will need to be used. According to teachings of the present invention, the set top box 106 includes software that analyzes available lighting and makes recommendations of any changes that would bring the lighting closer to a type, style or pattern of lighting selected by the user.

FIG. 2 is a block diagram of a video telephony capable home video system 200 including the television display 102, the set top box 106, the camera and a remote control 206 according to an embodiment of the invention. The set top box 106 can include a camera interface 208, processor 210, a program memory 212, a work space memory 214, a broadband network interface 216, a remote control transceiver 218, and a display driver 220 coupled together through a system bus 222. The broadband network interface 216 serves a dual purpose−to receive television programming and to send and receive video and audio when the system 200 is being used for video telephony. The display driver 220 which is coupled to the television display 102 is also used for both viewing television and for video telephony. Thus, the system 200 allows users to use their televisions to have audio and video telephony conversations from home or other locations where the system 200 may be set up. The remote control 206 is wirelessly coupled to the remote control transceiver 218. The remote control 206 also includes a beacon Light Emitting Diode (LED) 226 that emits a recognizable light signal that can be located by the camera 107. By inference, this allows the system 200 to locate a person (“the user”) using the system 200, who is presumed to be proximate the remote control 206 when the remote control 206 is actuated. A particular system for using the beacon LED 226 to locate the remote is taught in co-pending patent application Ser. No. 11/859,012 (Docket No. CML05644MHGCA) entitled “System and Method of Videotelephony with Detection of a Visual Token in the Videotelephony Image for Electronic Control of the Field of View” by Crenshaw, J. et al, which is assigned in common with the present application. The system 200 can then determine if the lighting level on the user is adequate or inadequate. The latter is but one mode of analyzing the lighting in a room in which the system 200 is situated.

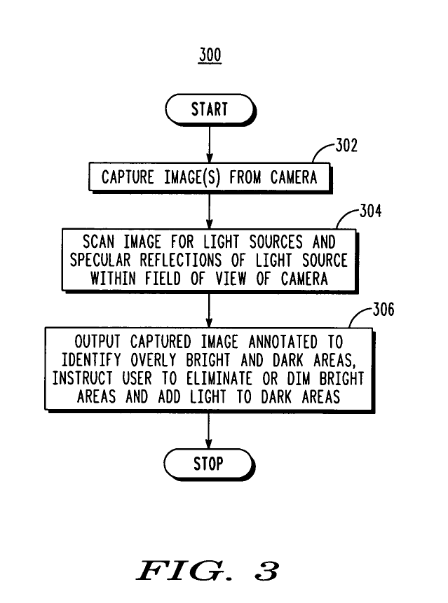

One or more sub-programs for analyzing images captured by the camera and recommending changes to improve lighting are stored in the program memory 212 and executed by the processor 210. The functioning of these sub-programs is described below in more detail with reference to FIGS. 3-7.

FIG. 3 is a flowchart of a first sub-program 300 executed by the set top box 106 according to an embodiment of the invention. Alternatively the sub-program is executed in a separate specialized apparatus. In block 302 an image or images are captured from the camera 107. High Dynamic Range Imaging (HDRI) may be used in block 302. HDRI uses multiple images captured with different integration times, in order obtain more accurate information of the brightness intensity of a scene using a camera that has a limited dynamic range. In block 304 the image is scanned for light sources and strong reflections of light sources and for very dark areas. Direct views of light sources or strong reflections can be identified as regions of the image that are markedly brighter than the average brightness of the image. In normal use, because the dynamic range of any camera 107 is limited, when there is a direct view of a light source or its specular reflection the auto exposure control system of the camera will darken the overall image, which may make foreground subjects, e.g., people using the home video system 200 too dark. Thus, in block 306 the set top box 106 will output the captured image with annotations identifying undesirable light sources or strong reflections of light sources that are visible to the camera 107 as well as areas that are poorly lit and could benefit from increased lighting. Bright areas created by light sources outside of the camera's current field of view are included. The system will present recommendations to the user to eliminate, dim, increase, add and/or modify the intensity or arrangement of light sources in order to reduce the negative impact of the light sources detected.

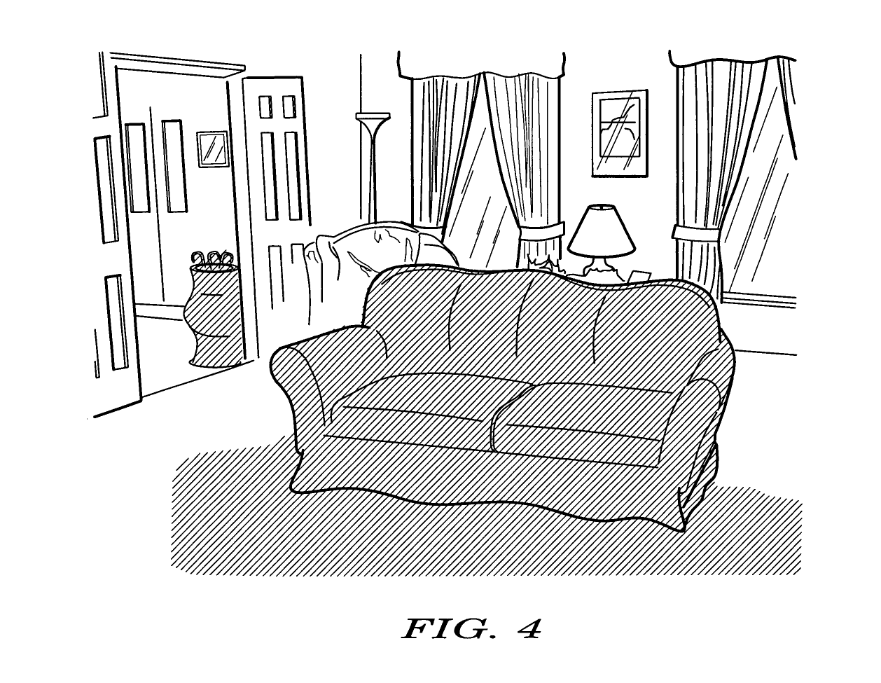

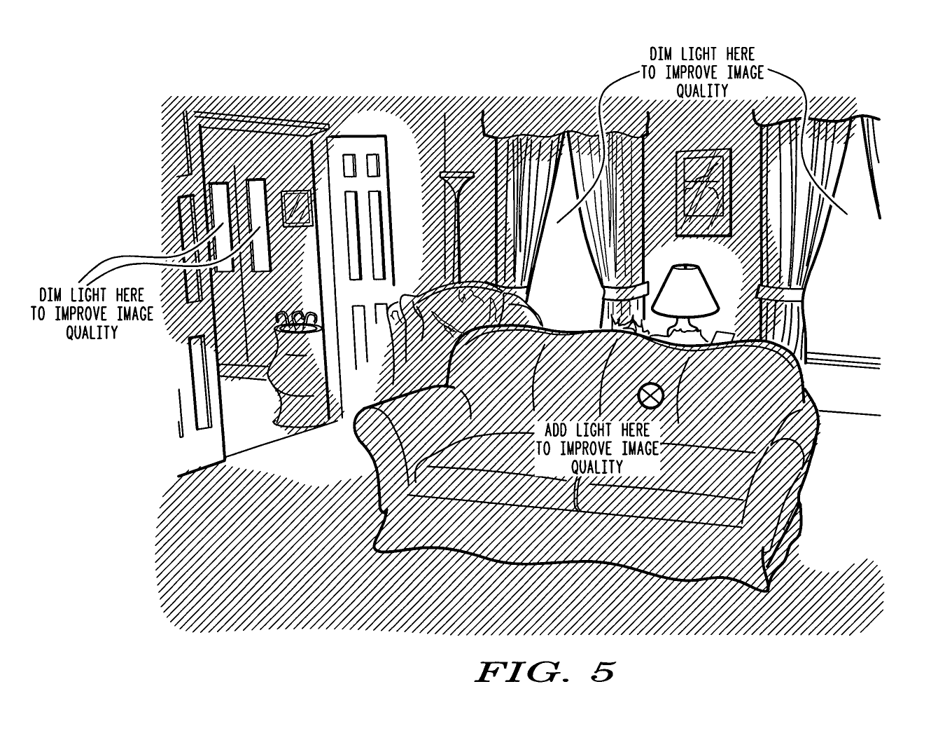

FIGS. 4-6 are a sequence of images illustrating the operation of the sub-program shown in FIG. 3. FIG. 4 shows a raw image captured by the camera 107. This image exhibits the problem of limited dynamic range described above. The auto-exposure control of the camera 107 has caused the user seated on the sofa 110 to be obscured in darkness because of the brightly lit windows 122, 124 in the background. FIG. 5 is an image that can be output in step 302 on the television display 102 in order to inform the user of excessively bright areas that should be dimmed and areas that are too dark and need be better lit. In FIG. 5 the bright windows 122, 124 are marked and a text message instructing the user is superposed on the image. The problem can be mitigated by closing or partially closing the curtains. If the detected light source were a lamp or a specular reflection of a lamp the problem could be addressed by the user moving, dimming, reorienting or turning off the lamp. The dark sofa 110 on which the user is seated is also marked and a text message instructing the user is superposed on the image.

Alternatively, if the field of view of the camera can be changed using an optical zoom lens, or using digital zooming, or more generally by selecting a portion of the field of view of the lens that is not necessarily on-axis then the set top box or other controlling system, can be programmed to change the field of view in order to exclude the direct views of the light source, while still keeping the user in the field of view. In doing so, in order to keep the user within the field of view, the system 200 must know the location of the user. One option for locating the user is to use the beacon LED 226 of the remote control 206. Note the location of the beacon LED 226 is marked in FIG. 5 by an X within a circle. Another option for locating the user or user's is to use a face detection sub-program.

As a further alternative, in addition to highlighting strong light sources in the image the system 200 can also output information indentifying dark areas that could benefit from additional lighting and present recommendations to the user to make appropriate changes to increase the lighting levels in those areas.

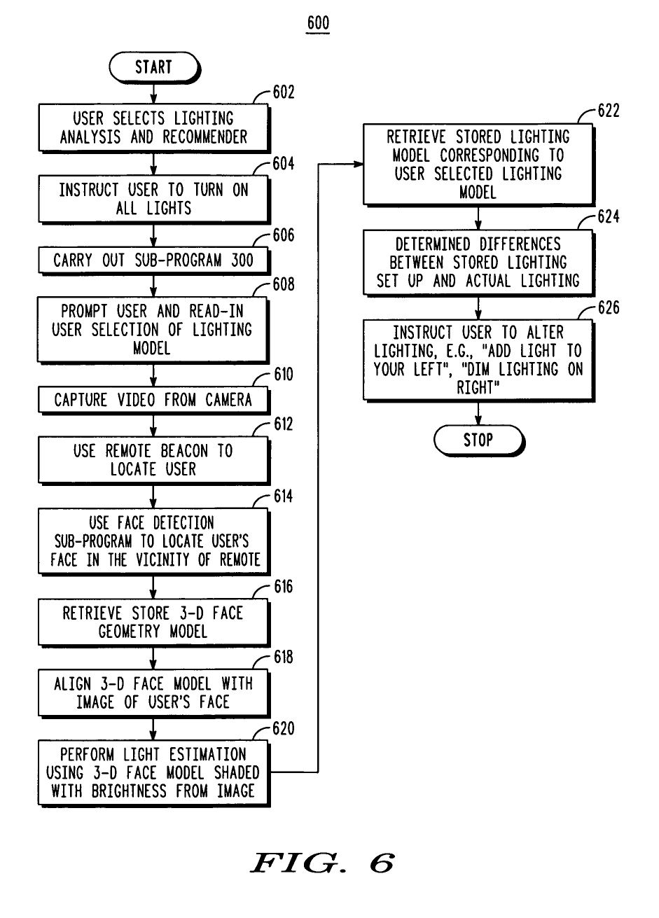

FIG. 6 is a flowchart of a second sub-program for analyzing and recommending changes to lighting 600 that is executed by the set top box 106 according to an embodiment of the invention. In block 602 the user uses the remote control 206 (or other input means) to initiate the sub-program 600. In block 604 the user is instructed, for example, by text displayed on the display 102 or by audio to turn on all the lights in the room. In block 606 sub-program 300 is executed. As discussed above, in the course of executing sub-program 300 the user will be advised of strong light sources in the field of view and will be presented with recommendations of methods to reduce any negative impact of those light sources, for example, dimming, blocking or turning off light sources.

In block 608 the user is prompted to select a style (model) of lighting that the user would like to use during video telephony. Examples of lighting models (also referred to as reference models) that might be programmed into the system 200 are “standard daytime”, “standard nighttime”, or stylized lighting such as “film noir” or “horror”. Each lighting model can describe lighting as a set of lamps each of which is described by its angular coordinates relative to the user and its brightness in the direction of the user. For example for standard daytime lighting at least two lamps, one in front of the user and to the user's left and one in front of the user and to the user's right are specified. The lighting model can also include information such as color balance or color temperature. The lighting model can alternatively include the Cartesian coordinates of light sources relative to the user. The lighting model can also include spectral distribution information, or information derived therefrom such as CIE color coordinates or color temperature. Alteration of colors, if necessary, can be accomplished electronically in the camera 107 or by the processor 210. Thus, for example the “standard nighttime” lighting model suitably specifies a lower color temperature, e.g., in the range of 3000K to 3200K whereas the “standard daytime” lighting model can specify a color temperature in the range of 5000K to 5500K. Future implementations may give the user the option to alter the color temperature of room lights that have tunable color temperatures.

In block 610 video from the camera 107 is captured. The video that is captured can include more than one frame. In block 612 the remote control 206 is located by scanning the captured video for a light signature corresponding to the beacon LED 226. The user is assumed to be holding the remote control, therefore in block 614 a face detection sub-program is optionally or additionally used to search the captured video for the user face in the vicinity of where the beacon LED 226 was detected. Numerous robust face detection programs that can be used in block 614 have been published. One such program is described in Turk, M., Pentland, A., Eigenfaces for Recognition, Journal of Cognitive Neuroscience, Vol. 3, No. 1, 1991. Another program is described in Lienhart, R. et al., Empirical Analysis of Detection Cascades of Boosted Classifiers for Rapid Object Detection, MRL Technical Report, May 2002, revised December 2002. Alternatively block 612 is not used and the face detection program begins searching at a likely position, e.g., the center of the image or in locations where people were detected on previous occasions.

Once the face is detected, in block 616 a stored 3-D face geometry model is retrieved from the program memory 212. The 3-D face model can be based on a Principle Component Analysis of a population of scanned faces. In block 618 the 3-D face model is oriented based on detected images of the user's face in the captured video. One method of accomplishing block 618 is described in Xin, L. et al, Automatic 3D Face Modeling from Video, Proceedings of the Tenth IEEE International Conference on Computer Vision (ICCV '05).

Once the 3-D face geometry model is oriented it can be used in block 620 to perform “light source estimation”. “Light source estimation” is a term of art referring to techniques for deducing the arrangement of light sources relative to subjects within the view of the camera 107. The light sources themselves are not assumed to be within the view of the camera 107. One method for light source estimation that can be used in block 620 to perform light source estimation is described in Hougen, D. R., Ahuja, N., Estimation of the Light Source Distribution and its Use in Integrated Shape Recovery from Stereo and Shading, Computer Vision, 1993. Proceedings., Fourth International Conference on Volume, Issue, 11-14 May 1993 Page(s):148-155.

In block 622 the lighting model (or reference model) that the user selected in block 608 is read from the program memory 212 and in block 624 differences between the stored lighting model and the actual room lighting, i.e., lighting levels and pattern of the environment in which the system is located, are determined. The stored lighting model can specify the illuminance and angular coordinates of one or more light sources (relative to the user position, with a coordinate system axis, e.g., Z-axis defined as extending between the camera and the user).

One possible algorithm for analyzing the differences between the stored lighting model and the actual room lighting is as follows. By using standard graphics techniques, a face model can be placed at an arbitrary position and models for a set of lights can be applied and an image can be rendered as an approximation of what the actual camera would have captured. When the reference model lighting is used to create the rendering, we call this Rr. For any lighting change relative to the lighting model from the real scene, some combination of elimination, movement, reduction or brightening will have been applied to the lights in the scene. We call such a change a configuration, Ck, where k is a number corresponding to a particular set of changed. For each configuration Ck, we can create a rendering, Rk. We can compute a cost measurement, F(Ri, Rj) between two renderings Ri and Rj, which is minimized when Ri and Rj are similar. One possible function would be a simple sum of absolute differences over all the corresponding pixels in the two renderings. It will be appreciated by one or ordinary skill in the art that there are many alternative functions that could be used for this purpose. Given the cost function F, and the reference rendering Rr, we can find an optimal configuration Ct such that F(Rt, Rr) is minimized. Although a face model has been used in this example, it should be clear to anyone skilled in the art that any object model could be used in this manner and furthermore a plurality of such models could be used simultaneously within the optimization algorithm.

In block 626 instructions are given to the user, e.g., via the display 102 or speakers 103 to alter the lighting in order to better match the existing lighting to the stored lighting model. The instructions can be of the nature of phrases such as “ADD LIGHT TO YOUR LEFT” or “DIM LIGHT TO YOUR RIGHT”, or even “MOVE LIGHT AT LEFT BACK” or “MOVE LIGHT AT RIGHT UPWARD”.

In addition to recommending changes aimed at achieving certain lighting on the user's face, the system 200 can also measure the background light level away from the user's face, and instruct the user to brighten or darken this light level.

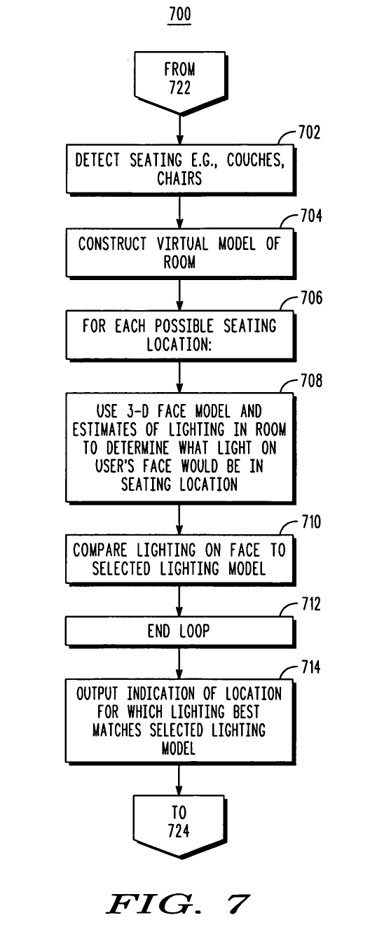

FIG. 7 shows an additional process 700 that can be carried out after block 622. In block 702 seating, e.g., sofas and chairs in the room 100 are detected. The orientation of the seating is also determined. The sub-programs for detecting and determining the orientation of seating are analogous to the sub-programs for detecting and determining the orientation of the user's face. In block 704 a virtual model of the room is constructed. Block 706 is the top of a loop that considers each possible seating location, e.g., each chair and multiple (e.g., 3) positions across each sofa. In block 708 the 3-D face model is used to determine what the lighting on the user's face would be for each seating position. In block 710 for each seating position, the determined lighting on the user's face is compared to the lighting model selected by the user in block 608. Block 712 represents the end of the loop. In block 714 an indication of the seating location at which the lighting on the user's face would best match the lighting model selected by the user is output to the user.

Although particular forms of flowcharts are presented above for the purpose of elucidating aspects of the invention, the actual logical flow of programs is dependent on the programming language in which the programs are written and the style of the individual programmer(s) writing the programs. The structure of programs that implement teachings of the present invention can be varied from a logical structure that most closely tracks the flowcharts shown in the FIGs. without departing from the spirit and scope of the invention as set forth in the appended claims.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A video telephony terminal comprising:
a processor coupled to a digital camera, a display and a memory storing a program that is executed by said processor, wherein said processor is programmed by said program to:
collect at least one image;
process said at least one image in order to analyze at least one light source in said at least one images;
based, at least in part on an analysis of said at least one light source, output information to a user as to how images collected by said digital camera can be improved.

2. The video telephone terminal according to claim 1 wherein said processor is further programmed to:
compare said analysis of said at least one light source to a stored reference model; and
compute a lighting change required to match said stored reference model.

3. The video telephone terminal according to claim 1 wherein in processing said at least one image in order to analyze said at least one light source in said image, said processor is programmed to:
detect at least one object in said image; and
to use a stored model of said at least one object along with said image to estimate locations of said at least one light source by using a light source estimation sub-program.

4. The video telephone terminal according to claim 3 wherein said at least one object is a human face.

5. The video telephone terminal according to claim 3 wherein in detecting said at least one object, said processor is programmed to detect a remote control by a signal beacon light source of the remote control.

6. The video telephone terminal according to claim 3 wherein in recognizing said at least one object in said image, said processor is programmed to recognize an object selected from the group consisting of:
a chair and a couch.

7. The video telephone terminal according to claim 1 wherein in outputting information to said user as to how images collected by said digital camera can be improved, said processor is programmed to output at least one recommended location for said user.

8. The video telephone terminal according to claim 1 wherein in outputting information to said user as to how images collected by said digital camera can be improved, said processor is programmed to output at least one recommended adjustment of lighting level to said user.

9. The video telephone terminal according to claim 1 wherein in outputting information to said user as to how images collected by said digital camera can be improved, said processor is programmed to output at least one recommended change in physical location of a light source to said user

10. A video telephony terminal comprising:
a processor coupled to a digital camera, a display and a memory storing a program that is executed by said processor, wherein said processor is programmed by said program to:
detect a light source visible within a field of view of the digital camera;
detect a user in the field of view;
change the field of view to remove the light source from the field of view while keeping the user in the field of view.
